(19) United States
(12) Patent Application Publication
(10) Pub. No.: US 2016/0238224 A1
(43) Pub. Date: Aug. 18, 2016

(54) MULTI-PURPOSE LIGHT EMITTING DIODE FLARE WITH PIVOT ARM

(71) Applicant: Marche International LLC, Lawrence, KS (US)

(72) Inventor: Christopher J. Ostrander, Lawrence, KS (US)

(21) Appl. No.: 15/136,033

(22) Filed: Apr. 22, 2016

Related U.S. Application Data
(63) Continuation-in-part of application No. 14/884,579, filed on Oct. 15, 2015.
(60) Provisional application No. 62/150,963, filed on Apr. 22, 2015.
(60) Provisional application No. 62/064,332, filed on Oct. 15, 2014.

(51) Int. Cl. F21V 23/04; F21V 21/26; F21V 21/14; F21L 4/02; F21V 33/00

(52) U.S. Cl. CPC F21V 23/0414; F21L 4/02; F21V 23/0407; F21V 33/00; F21V 21/145; F21V 21/26; F21Y 2101/02; F21Y 2113/005

(57) ABSTRACT

A portable electric flare including a two-sided panel, each side containing a grid of light-emitting diodes (LEDs). In an exemplary embodiment one side would include typical white or standard colored LEDs and the other side would include red or other color LED. The panel of LEDs is connected to an arm which is connected to a base by a hinge or a pin. The panel and arm may be tilted up away from the base if the base is placed on a flat surface, such that the panel is some angle between zero degrees and 90 degrees away from the base. A preferred embodiment would allow the arm to stop at any angle, but it should at least stop perpendicular to the base at 90 degrees. This allows the LED to be viewed from passersby while the base provides a solid support preventing the flare from tipping.

### CROSS REFERENCE TO RELATED APPLICATION

This application claims priority in U.S. Provisional Patent Application No. 62/150,963, filed Apr. 22, 2015, and is a continuation-in-part of U.S. patent application Ser. No. 14/884,579, filed Oct. 15, 2015, which claims priority in U.S. Provisional Patent Application No. 62/064,332, filed Oct. 15, 2014, all of which are incorporated herein by reference.

### BACKGROUND OF THE INVENTION

1. Field of the Invention

The present invention relates generally to a light-emitting diode (LED) road flare, and more specifically to a multi-purpose, multi-function LED road flare and utility instrument.

2. Description of the Related Art

Typical chemical road flares are dangerous, unpredictable, and finite. These flares burn hot and pose fire risks. They degrade over time and may not be functional in a time of need. Once their fuel burns down, they are useless.

Existing electronic road lights and road flares, including those using light-emitting diodes (LEDs) have been used in recent years. Typically, these devices are designed merely to replace the chemical road flares of years past. However, in doing so these LED flares do not improve upon the prior art other than to exchange the light source from the fire of a road flare to the light emitted from the LED.

What is needed is an LED road flare which embraces the obvious advantages of the LED and incorporates those advantages into a road flare device which has multiple useful features.

Heretofore there has not been available a multi-purpose LED flare with the advantages and features of the present invention.

### BRIEF SUMMARY OF THE INVENTION

The present invention generally provides a portable electric flare including a two-sided panel, each side containing a grid of light-emitting diodes (LEDs). In an exemplary embodiment one side would include typical white or standard colored LEDs and the other side would include red or other color LED. Alternatively, each side could contain six white LEDs surrounding a single red LED, or some combination thereof

Each panel has several modes of lighting, which are selectable via a power switch or other switch. The different modes include solid lights, blinking lights, off, or a combination thereof. For example, the red side of the panel may be set to blinking or flashing, while the white side of the panel could be constantly lit. This creates a flashing hazard strobe facing away from a vehicle to warn oncoming vehicles, and a solid white light source aimed towards the vehicle to assist with repairs or other tasks.

The panel of LEDs is connected to an arm which is connected to a base by a hinge or a pin. The panel and arm may be tilted up away from the base if the base is placed on a flat surface, such that the panel is some angle between zero degrees and 90 degrees away from the base. A preferred embodiment would allow the arm to stop at any angle, but it should at least stop perpendicular to the base at 90 degrees. This allows the LED to be viewed from passersby while the base provides a solid support preventing the flare from tipping.

The LED may be powered by replaceable batteries, such as standard AA or AAA Lithium Ion batteries, or it may contain a semi-permanent rechargeable battery and recharge port.

### BRIEF DESCRIPTION OF THE DRAWINGS

The drawings constitute a part of this specification and include exemplary embodiments of the present invention illustrating various objects and features thereof.

FIG. 1 top plan view of a preferred embodiment of the present invention when placed on a flat surface in a down position.

FIG. 2 is a plan view of the bottom side thereof.

FIG. 3 is a left side elevational view thereof

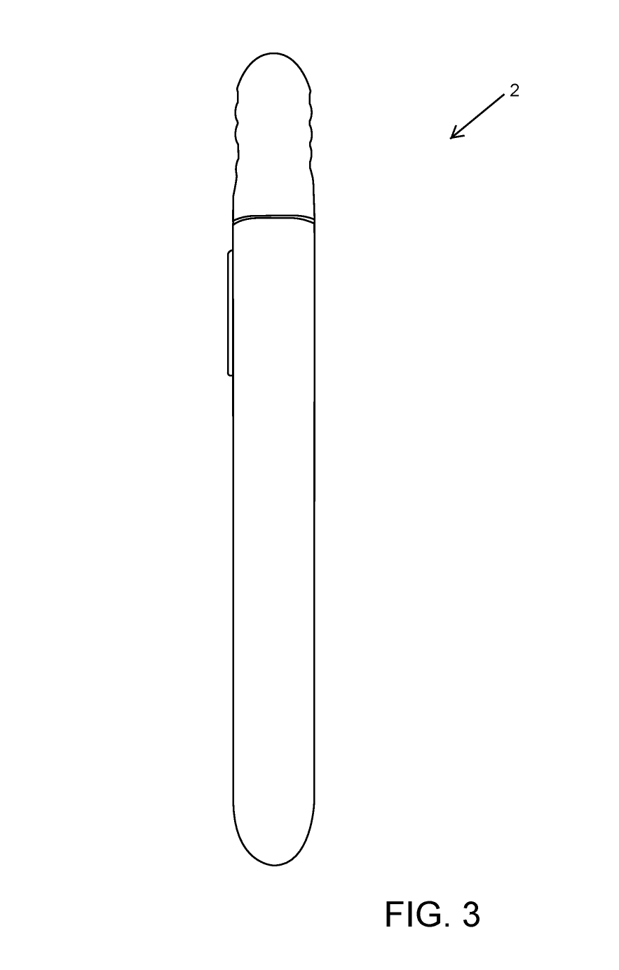

FIG. 4 is a right side elevational view thereof.

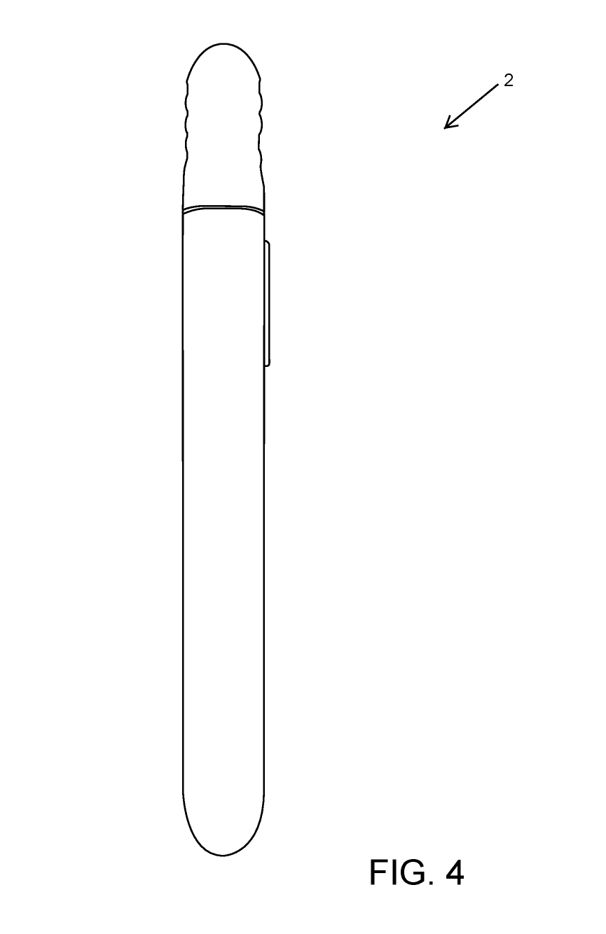

FIG. 5 is a front side elevational view thereof.

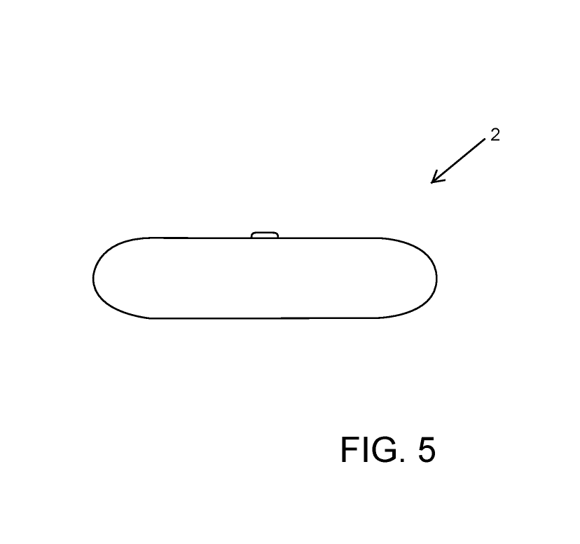

FIG. 6 is a back side elevational view thereof.

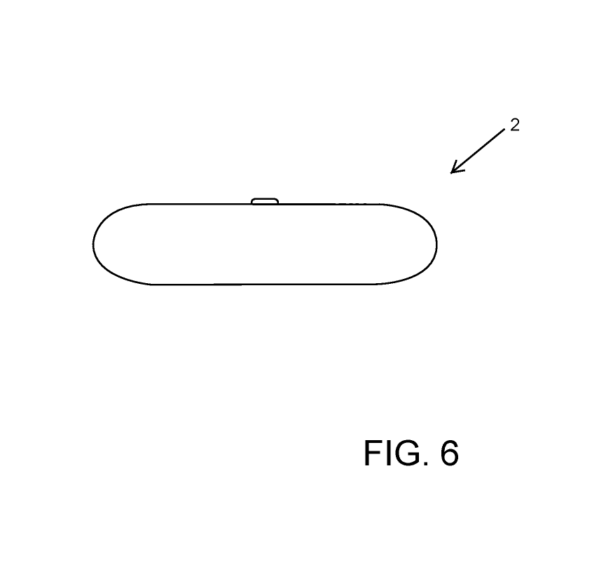

FIG. 7 is an isometric view of a preferred embodiment of the present invention when placed on a flat surface in a down position.

FIG. 8 is an isometric view of a preferred embodiment of the present invention when placed on a flat surface in a partially raised position.

FIG. 9 is an isometric view of a preferred embodiment of the present invention when placed on a flat surface in a fully raised, perpendicular, or “T” position.

### DETAILED DESCRIPTION OF THE PREFERRED EMBODIMENTS

### I. Introduction and Environment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment Light-Emitting Diode (LED) Flare 2

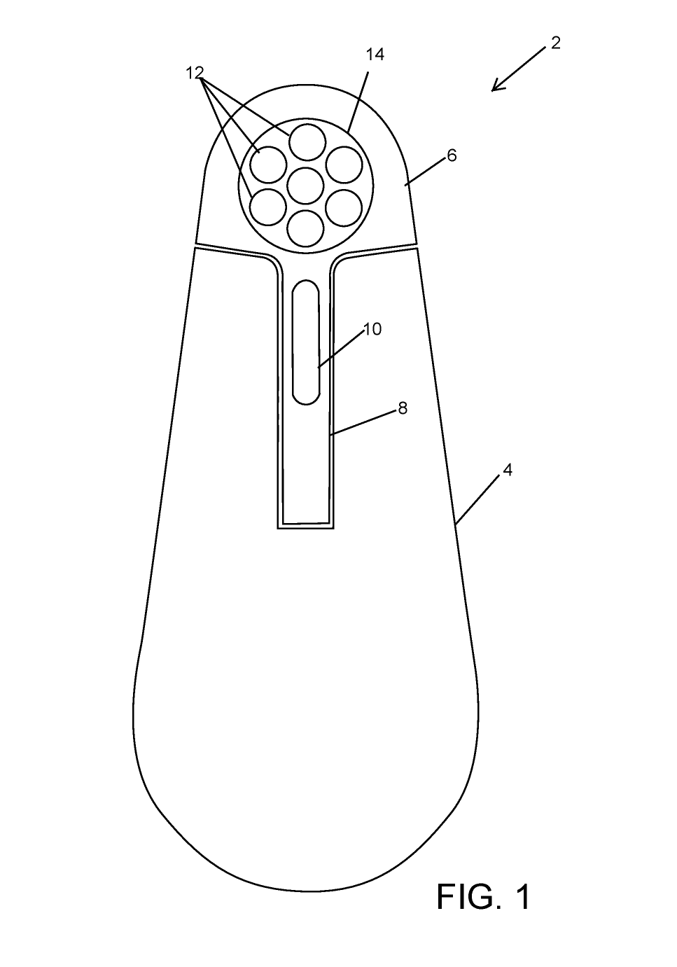

Referring to the figures, FIG. 1 shows a top plan view of an LED flare 2 placed on a flat surface. The flare generally includes a base 4, a light housing 6, and an arm 8 connecting the light housing 6 to the base 4 via a pin, hinge, or other connecting element. The light housing 6 includes a front face 14 and a rear face 16, each containing a plurality of LEDs 12. A switch 10 is located on the arm 8. The switch is capable of turning on and off the LED lights 12. The switch may also unlock the arm 8 and light housing 6 in some embodiments, thereby allowing the housing and arm to pivot away from the base 4 to an angle between zero and ninety degrees.

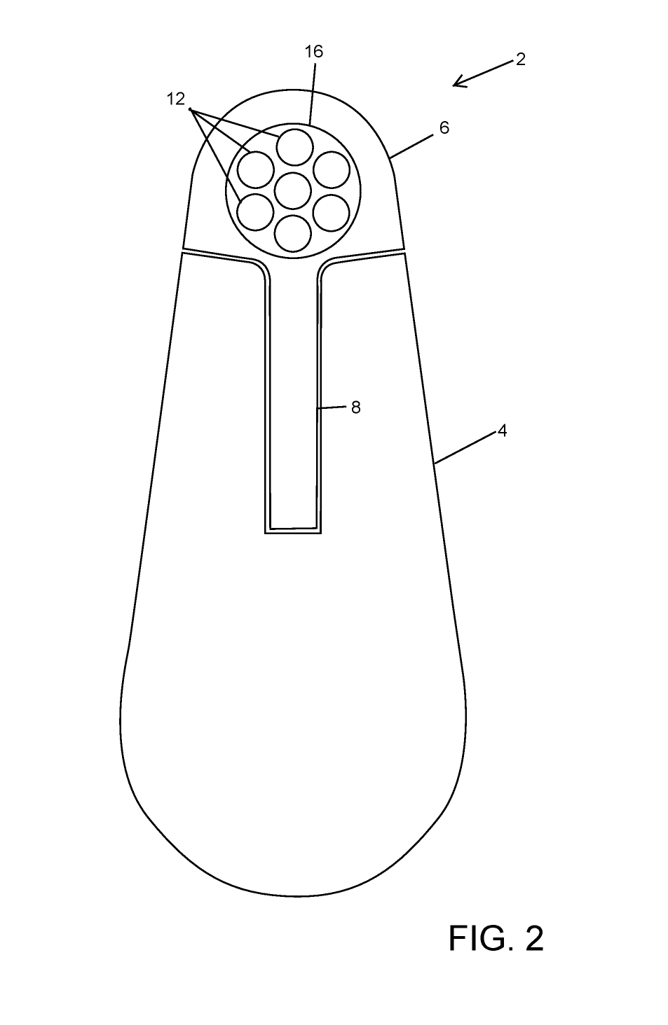

FIG. 2 shows the reverse view of FIG. 1, including the rear face 16 of LEDs 12.

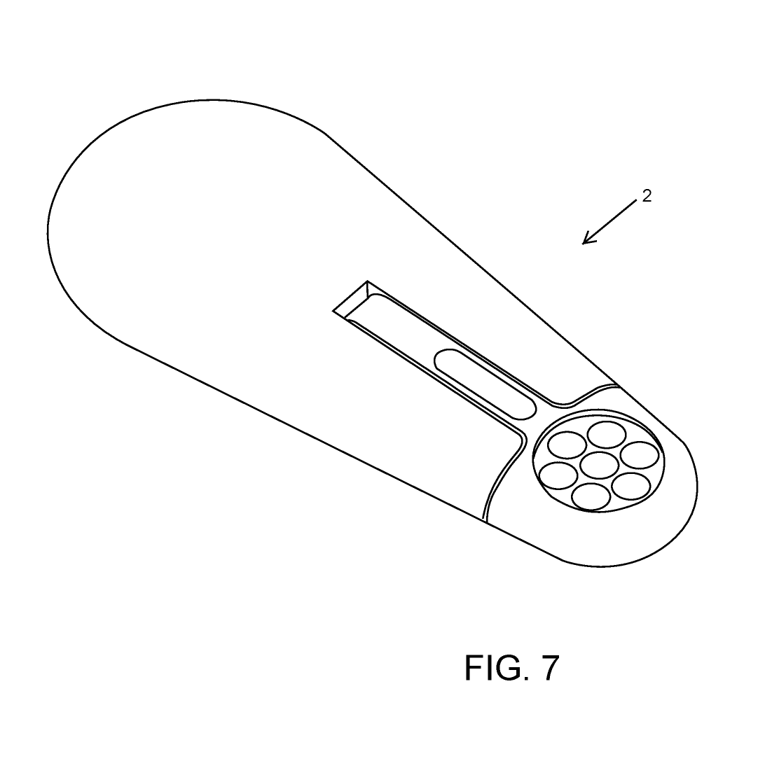

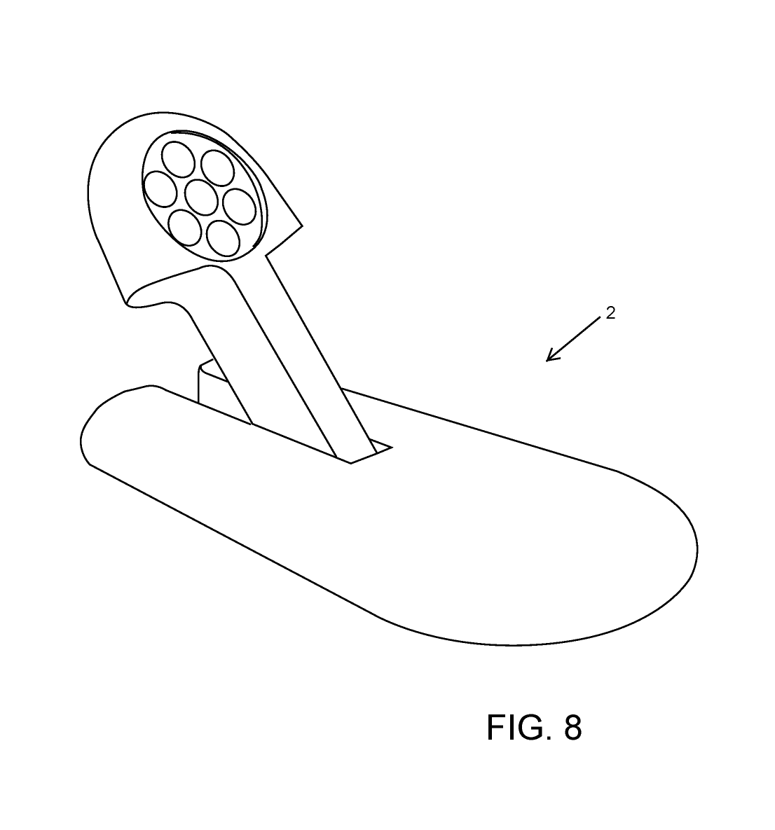

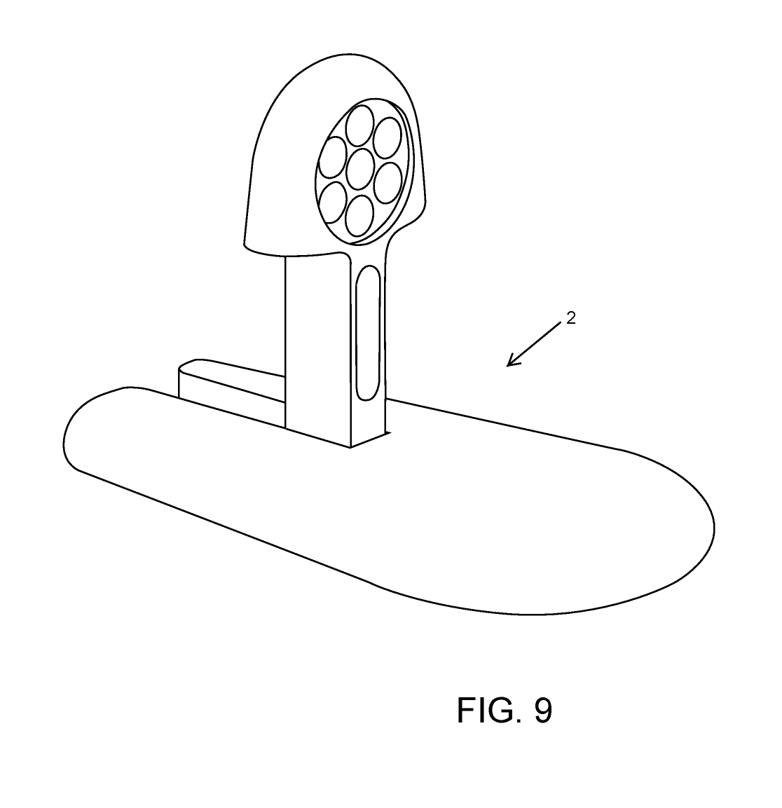

FIGS. 7-9 show the progression of the flare 2 as the pivot arm 8 and light housing 6 are pivoted away from the base 4 when the base is placed on a flat surface. The pivot arm 8 can be stopped at any angle between zero degrees and ninety degrees away from the base 4. This allows the user to direct the angle of the flare faces 14, 16 as appropriate. For example, if the base were to be placed on an angled surface, such as on the surface of a vehicle, and secured there with a magnet placed internally within the base 4, the arm 8 would not have to pivot away from the base 4 at as steep of an angle.

The flare 2 features two faces 14, 16 of LED lights 12. The switch 10 cycles through lighting options. In a preferred embodiment there are at least three possible lighting options. With a first activation of the switch 10 the white LEDs will turn on while the red LEDs will remain off. This allows the flare to be used as a flashlight to light up a scene of an accident or other location. The second activation of the switch turns the white LEDs off and activates the red LEDs such that they are flashing on and off. This allows the flare 2 to be used as a warning element to other passing traffic while the user's vehicle is pulled over to the side of the road or for any other emergency situation. The third activation of the switch 10 will activate both faces of LEDs. This allows the user to set the flare down in a way that the white LEDs light up the area where the user is working while the red LEDs face in the direction of oncoming traffic to warn them of the scene. The fourth activation of the switch would turn all LEDs off. However, any combination of flashing or solid lights could be programmed into the switch 10 and delivered by the LEDs.

The flare 2 could alternatively, or preferably, be used as a general work light for indoor or outdoor jobs. For example, the light could be used for automobile repair work in a dimly lit garage or during the night. In such an instance, the lights facing towards the work area would be in a constant “on” arrangement, where there is no flashing. The lights facing away from the work area could be flashing to warn oncoming traffic that work is being done at that location, or those lights could also be in a constant “on” arrangement to produce additional light, or those lights could be in an “off” arrangement.

Other examples of common use for the flare 2 would be as a lantern for camping or other outdoor activities. The flare could be placed on a picnic table or outside of a tent for temporary, directional lighting. The flare design suits it for carrying as a lantern.

It is to be understood that while certain embodiments and/or aspects of the invention have been shown and described, the invention is not limited thereto and encompasses various other embodiments and aspects.

Having thus described the invention, what is claimed as new and desired to be secured by Letters Patent is:

1. A light emitting diode (LED) flare comprising:
a base including a recess for receiving a pivot arm;
a translucent housing hingedly connected to said base by said pivot arm, said pivot arm configured to position said housing at any angle between zero degrees and ninety degrees away from said base;
said housing including a first face and a second face, said first face including a first set of light emitting diodes (LEDs), and said second face including a second set of LEDs;
a switch configured to operate said first and second sets of LEDs; and
a power source stored within said base and electrically connected to said LEDs through said pivot arm.

2. The LED flare of claim 1, further comprising a panel within said housing, said panel configured for receiving said first set of LEDs and said second set of LEDs.

3. The LED flare of claim 1, further comprising:
said power source comprising a battery;
a battery base assembly comprising a battery housing configured for storing said battery, a removable cover and wiring configured to electrically connect said battery to said first and second sets of LEDs; and
wherein said battery base assembly is contained within said base.

4. The LED flare of claim 1, wherein said base is comprised of a semi-flexible material having a high coefficient of friction.

5. The LED flare of claim 1, further comprising:
said first set of LEDs configured to produce a white light; and
said second set of LEDs configured to produce a red light.

6. The LED flare of claim 5, wherein said switch is configured to activate said first set of LEDs only.

7. The LED flare of claim 5, wherein said switch is configured to activate said second set of LEDs only.

8. The LED flare of claim 5, wherein said switch is configured to activate both first and second sets of LEDs simultaneously.

9. The LED flare of claim 8, wherein said first set of LEDs are configured to flash on and off once activated.

10. The LED flare of claim 8, wherein said second set of LEDs are configured to flash on and off once activated.

11. The LED flare of claim 1, wherein said switch is further configured to release said pivot arm from a first, locked position to a second, pivoted position at an angle between one degree and ninety degrees from said base.
